(19) United States
(12) Patent Application Publication
(10) Pub. No.: US 2021/0109880 A1
(43) Pub. Date: Apr. 15, 2021

(54) PIN CONTROL METHOD

(71) Applicant: Realtek Semiconductor Corp., HsinChu (TW)

(72) Inventor: Chin-Hung Lu, Hsinchu County (TW)

(21) Appl. No.: 17/070,870

(22) Filed: Oct. 14, 2020

(30) Foreign Application Priority Data
Oct. 15, 2019 (TW) 108136972

(51) Int. Cl. G06F 13/40; G06F 1/22

(52) U.S. Cl. CPC G06F 13/409; G06F 1/22

(57) ABSTRACT

An integrated circuit includes a plurality of peripheral input/output pins, a plurality of general-purpose input/output pins, a link network, and a network control circuit. The link network is coupled to the plurality of peripheral input/output pins and the plurality of general-purpose input/output pins. The network control circuit is coupled to the link network, and controls the respective connections between the plurality of peripheral input/output pins and the plurality of general-purpose input/output pins via the link network according to correspondence between the plurality of peripheral input/output pins and the plurality of general-purpose input/output pins.

### BACKGROUND OF THE INVENTION

### 1. Field of the Invention

The present invention is related to a pin control method, and more particularly to a dynamic pin control method applied to an integrated circuit.

### 2. Description of the Prior Art

With the development of semiconductor manufacturing technology growing from micrometer scale to nanometer scale, the function of integrated circuits has not stopped improving. As semiconductor manufacturing technology evolves, the number of electronic components per unit area is also increased by multiple times. However, due to the relatively limited improvement in the soldering technology, wire size and packaging technology, the soldering size or area required by pins of an integrated circuit cannot be shrunk equally. Therefore, in the integrated circuit, the cost of pins can be significant. Since the cost of integrated circuit area is quite expensive, an increase in the number of pins means an increase in cost. Furthermore, an increase in the number of electronic components per unit area means that more pins are required in the same package, and the number of pins will also directly affect the yield of chip packaging.

Traditionally, the integrated circuit has clear pin definitions after packaging. Therefore, after the integrated circuits are packaged, the pin definitions of the integrated circuit cannot be changed, causing restrictions on the circuit board layout for the system manufacturer. To change the pin definitions, the manufacturer would have to check the positions of the input pins and output pins of the integrated circuit and connect the input pins to the corresponding output pins via multi-level multiplexers according to the pin configuration table. That is, in addition to derive the pin configuration of the packaged integrated circuit, the manufacturer also needs the pin configuration table to set up the multi-level multiplexers for providing the new pin configuration. Therefore, if an input pin of the integrated circuit is desired to be connected to different output pins flexibly, more complicated multi-stage multiplexers would be needed, which requires even greater area and complicated designing processes.

### SUMMARY OF THE INVENTION

One embodiment of the present invention discloses an integrated circuit. The integrated circuit includes a plurality of peripheral input/output pins, a plurality of general-purpose input/output pins, a link network, and a network control circuit.

The link network is connected to the plurality of peripheral input/output pins and the plurality of general-purpose input/output pins. The network control circuit is coupled to the link network, and controls the respective connections between the plurality of peripheral input/output pins and the plurality of general-purpose input/output pins via the link network according to correspondence between the plurality of peripheral input/output pins and the plurality of general-purpose input/output pins.

Another embodiment of the present invention discloses a dynamic pin control method applied to an integrated circuit. The integrated circuit includes a plurality of peripheral input/output pins, a plurality of general-purpose input/output pins, a link network connected to the plurality of peripheral input/output pins and the plurality of general-purpose input/output pins, and a network control circuit coupled to the link network.

The dynamic pin control method includes the network control circuit generating a control signal according to correspondence between the plurality of peripheral input/output pins and the plurality of general-purpose input/output pins, and controlling respective connections between the plurality of peripheral input/output pins and the plurality of general-purpose input/output pins via the link network according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an integrated circuit according to one embodiment of the present invention.

FIG. 2 shows the Benes network according to one embodiment of the present invention.

FIGS. 3A and 3B show the routings between the different integrated circuits.

FIG. 4 shows the IC in FIG. 1 using a software program to control the connection between the peripheral input/output pins and the general-purpose input/output pins.

FIG. 5 shows the flow chart of the dynamic pin control method.

FIG. 6 shows the pin control register for storing the pin configuration.

FIG. 7 shows an integrated circuit according to one embodiment of the present invention.

FIG. 8 shows the Benes network according to one embodiment of the present invention.

FIG. 9 shows the sequences generated when adopting the Complete Residue Partition Tree Control algorithm.

FIG. 10 shows the flowchart of performing the Complete Residue Partition Tree Control algorithm to the first block in Benes network.

FIGS. 11A and 11B show the controlling manner according to one embodiment of the present invention.

FIG. 12 shows the control states of the switches in the first block of the Benes network.

FIG. 13 shows the flowchart of performing the bit control algorithm to the second block in the Benes network.

FIG. 14 shows all the control states of the switches in the Benes network.

### DETAILED DESCRIPTION

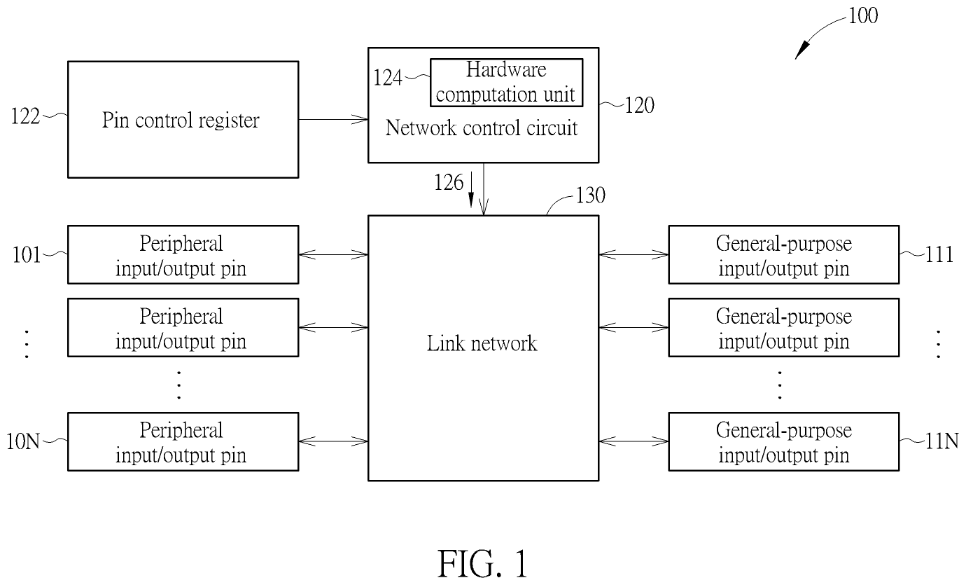

FIG. 1 shows an integrated circuit (IC) 100 according to one embodiment of the present invention. The IC 100 includes peripheral input/output pins 101 to 10N, general-purpose input/output pins 111 to 11N, a pin control register 122, a link network 130, and a network control circuit 120. The link network 130 is connected to the peripheral input/output pins 101 to 10N and the general-purpose input/output pins 111 to 11N. The network control circuit 120 is coupled to the link network 130, and can control the respective connections between the peripheral input/output pins 101 to 10N and the general-purpose input/output pins 111 to 11N via the link network 130 according to correspondence or connection relationship between the peripheral input/output pins 101 to 10N and the general-purpose input/output pins 111 to 11N.

The pin control register 122 can store the correspondence or connection relationship between the peripheral input/output pins 101 to 10N and the general-purpose input/output pins 111 to 11N. When the correspondence or connection relationship needs to be adjusted dynamically, for example, if the peripheral input/output pin 101 is to be connected to the general-purpose input/output pin 118 and the peripheral input/output pin 102 is to be connected to the general-purpose input/output pin 116, then such correspondence or connection relationship would be updated to the pin control register 122. The pin control register 122 can transmit the correspondence or connection relationship of pins as data to the hardware computation unit 124 of the network control circuit 120 to generate a control signal 126. The link network 130 would control the switches according to the control signal 126 to achieve the desired pin connections. In some embodiments of the present invention, the pin control register 122 can be independently disposed outside of the IC 100, and can be coupled to the network control circuit 120 of the IC 100.

In some embodiments of the present invention, the peripheral input/output pins 101 to 10N can be the function pins of the IC 100. The function pins of the IC 100 can include, but not limited to, the read control pin (RD), the interrupt request pin (INT), the write control pin (WR), the memory access control pin, and the system reset pin. After the hardware computation unit 124 derives and generates the control signal 126, the network control circuit 120 will adjust the connection between the function pins of the IC 100 and the general-purpose input/output pins 111 to 11N via link network 130 according to the control signal 126.

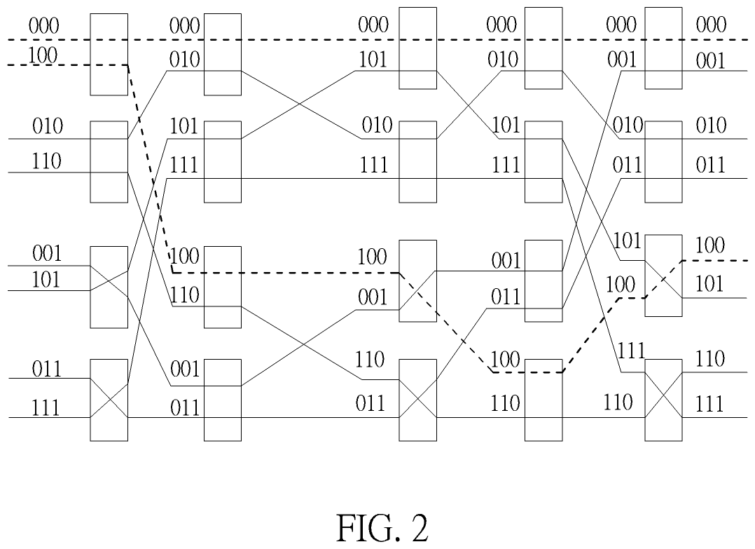

FIG. 2 shows the Benes network. In some embodiments, the link network 130 can be implemented by Benes network. In the Benes network, since each path from an input terminal to an output terminal would have the same number of gates, the issue of different gate delays for different paths can be avoided. As shown in FIG. 2, the path from the left terminal 000 to the right terminal 000 will pass through 5 gates. Similarly, the path from the left terminal 100 to the right terminal 100 will also pass through 5 gates. In the traditional scheme using the multi-level multiplexers or the crossbar switches, both the complexity and the area will increase when the number of positions of the pins to be connected increases due to the increasing number of gates and the complicated configuration. Furthermore, since different paths may be formed with different connections of the multiplexers, the numbers of gates for different paths between different input terminals and different output terminals may be very different in some cases. For example, one path may pass through one gate while the other path may pass through 19 gates. Therefore, when the Benes network is applied, the issue of different gate delays for different paths caused by the multi-level multiplexers or the crossbar switches can be avoided.

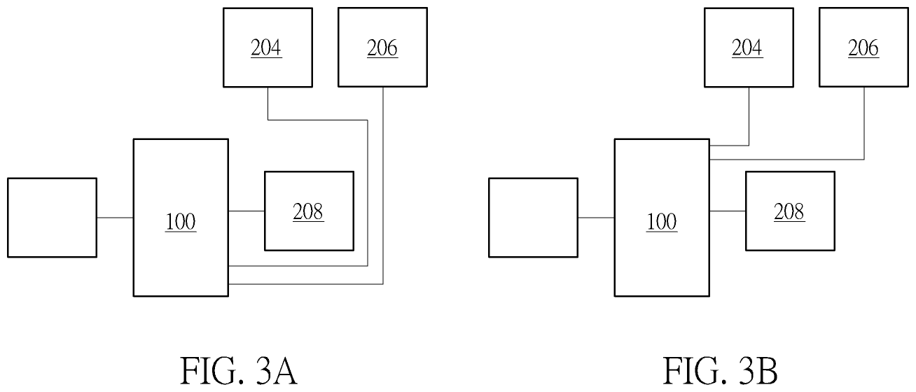

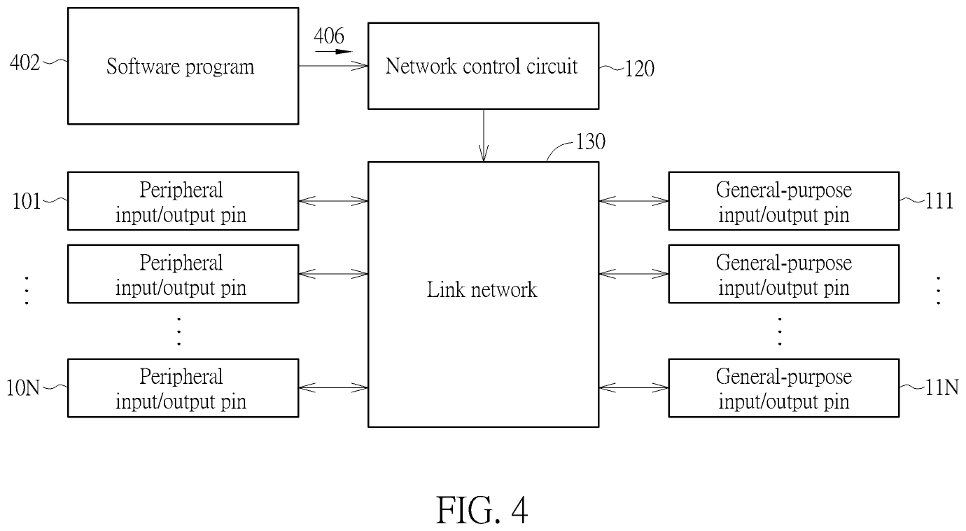

In one embodiment of the present invention, the issue of circuit board routing caused during IC placement can be alleviated. FIGS. 3A and 3B show the routings between the IC 100 and the other ICs 204, 206 and 208. In FIGS. 3A and 3B, the placement of the IC 100 is fixed. In prior art, since the output pins of the IC 100 are fixed and unchangeable, the routings between the ICs 206 and 100 and the routings between the ICs 204 and 100 can be difficult. However, with the network control circuit 120 provided by the embodiments of the present invention, the output pins of the IC 100 become changeable or can be modified according to needs. Therefore, in FIG. 4, the routings for the ICs 204 and 206 become easier, and the current interference or magnetic interference caused by bad routing can be reduced.

FIG. 4 shows the IC 100 using a software program 402 to control the connection between the peripheral input/output pins 101 to 10N and the general-purpose input/output pins 111 to 11N. The IC 100 includes the peripheral input/output pins 101 to 10N, the general-purpose input/output pins 111 to 11N, the link network 130 and the network control circuit 120. The network control circuit 120 can include the software program 402, and can be coupled to the link network 130. The link network 130 can be implemented by the Benes network to connect the peripheral input/output pins 101 to 10N and the general-purpose input/output pins 111 to 11N. When the correspondence or connection relationship between the peripheral input/output pins 101 to 10N and the general-purpose input/output pins 111 to 11N needs to be adjusted dynamically, the updated correspondence or connection relationship can be load to the software program 402. When the software program 402 generates the control signal 406, the control signal 406 will have the network control circuit 120 control the link network 130. The link network 130 will control the switches to connect the peripheral input/output pins 101 to 10N and the general-purpose input/output pins 111 to 11N according to the control signal 406. In some embodiments, the software program 402 can be disposed independently outside of the IC 100, and the control signal 406 can be transmitted to the network control circuit 120 from outside.

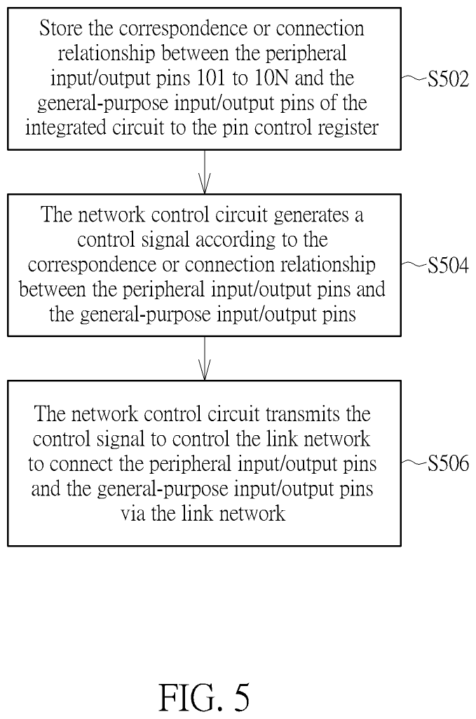

FIG. 5 shows the flow chart of the dynamic pin control method.

S502: store the correspondence or connection relationship between the peripheral input/output pins 101 to 10N and the general-purpose input/output pins 111 to 11N of the integrated circuit 100 to the pin control register 122;

S504: the network control circuit 120 generates a control signal according to the correspondence or connection relationship between the peripheral input/output pins 101 to 10N and the general-purpose input/output pins 111 to 11N;

S506: the network control circuit 120 transmits the control signal 126/406 to control the link network 130 to connect the peripheral input/output pins 101 to 10N and the general-purpose input/output pins 111 to 11N via the link network 130.

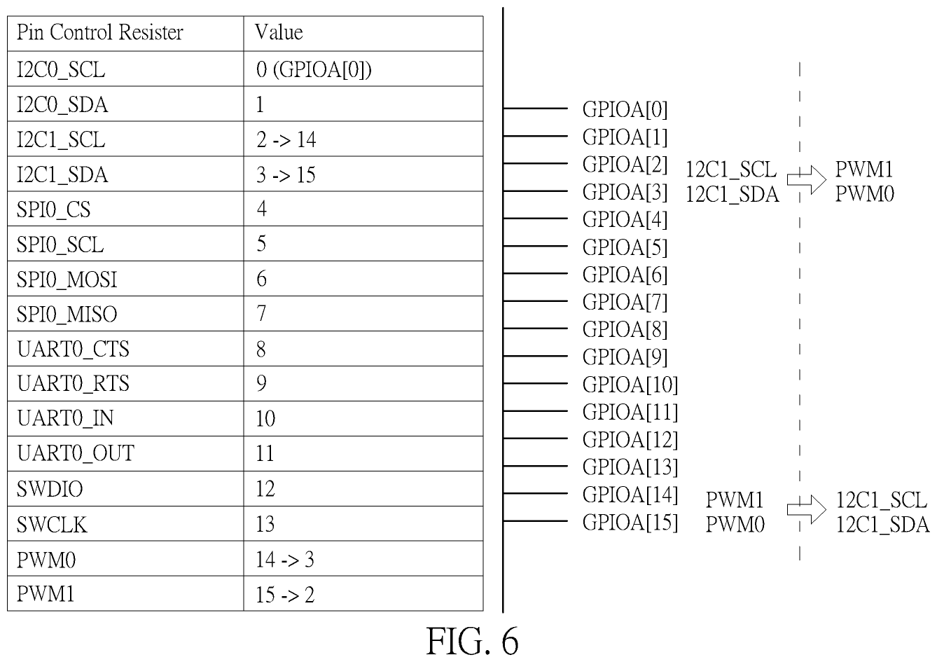

In step S502, the correspondence or connection relationship between the peripheral input/output pins 101 to 10N and the general-purpose input/output pins 111 to 11N via the link network 130 can be stored to the pin control register 122. In this case, the pin configuration can be adjusted by updating the pin control register 122. As shown in FIG. 6, when it is desired to change the pin for I2C from GPIOA[2] and GPIOA[3] to GPIOA[14] and GPIOA[15], it can be achieved by altering the content of the pin control register 122 without using lookup tables. After the pin configuration is adjusted, the updated pin configuration can also be derived by reading the content of the pin control register 120. According to the correspondence or connection relationship of the pins stored in the pin control register 122, the hardware computation unit 124 of the network control circuit 120 can generate the control signal 126 to control the respective connections of the Benes network. In tradition, when the multi-level multiplexers or the crossbar switches are used, the complexity and area will increase as the number of positions of the pins to be connected increases. Also, the process of looking up the tables to achieve the desired configuration will be more and more complicated. However, the embodiments of the present invention can provide a convenient method to control the pins dynamically.

In step S504, the network control circuit 120 can generate the control signal 126 by using complete residue partition tree control and bit control according to the correspondence or connection relationship between the peripheral input/output pins 101 to 10N and the general-purpose input/output pins 111 to 11N. In some embodiments, the control signal 126 can be generated by the hardware computation unit 124, and in some other embodiments, the control signal 406 can be generated by the software program 402. The link network 130 can be the Benes network. The control signal 126 and 406 can be used to control the gates of the Benes network so as to achieve the desired connections between the peripheral input/output pins 101 to 10N and the general-purpose input/output pins 111 to 11N

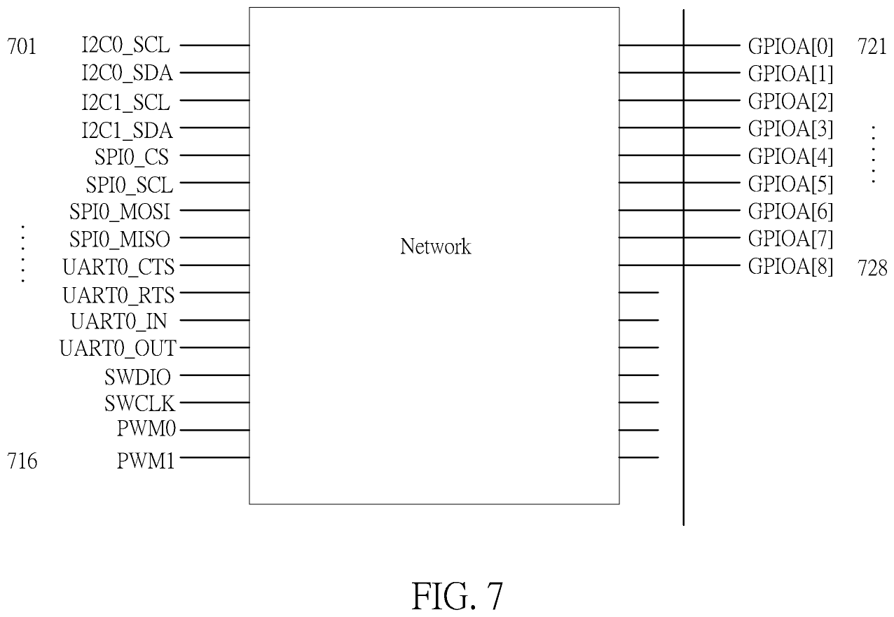

FIG. 7 shows an IC according to one embodiment of the present invention. In FIG. 7, the number of the general-purpose input/output pins 721 to 728 on the right is smaller than the number of the peripheral input/output pins 701 to 716 on the left. If the traditional packaging method is used, some of the peripheral input/output pins 701 to 716 may not be able to be adopted, that is, some compromises must be made. With the dynamic pin control method provided by the embodiments of the present invention, the general-purpose input/output pins 721 to 728 can be coupled to the peripheral input/output pins 701 to 716 via the link network 130 according to the needs. Therefore, all of the peripheral input/output pins 701 to 716 can be used effectively. Also, since the link network 130 is Benes network, the number of gates on each path is the same, so the issue of different delay times on different paths can be avoided.

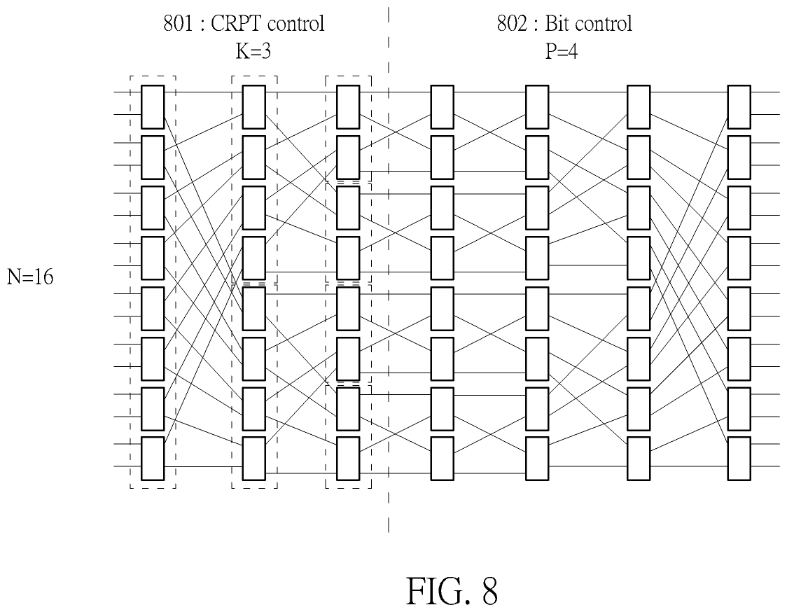

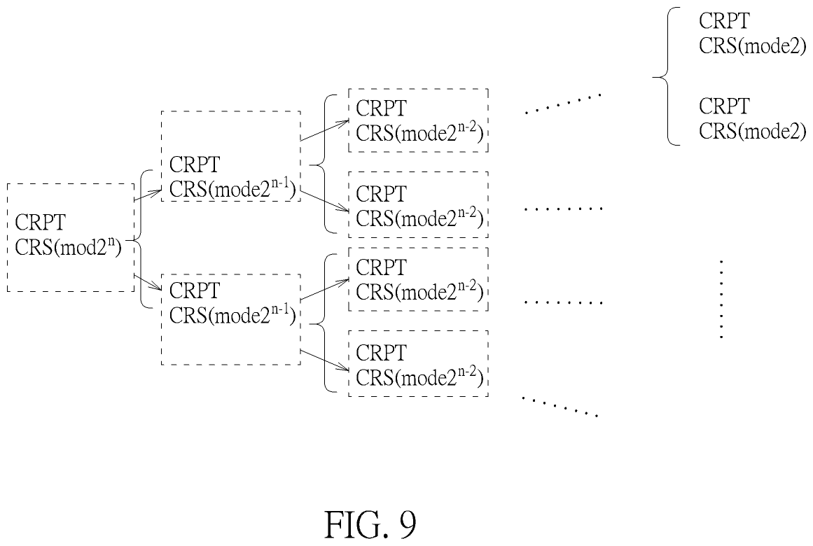

FIG. 8 shows the Benes network according to one embodiment of the present invention. In FIG. 8, the Benez network has N input terminals and is divided into two blocks. The control signal used for controlling the first block 801 is generated by the Complete Residue Partition Tree Control (CRPT Control) algorithm. The first block 801 includes K stages, where K=log₂ N−1 as shown in FIG. 9. In the present embodiment, as shown in FIG. 8, if N=16, then the first block 801 will have 3 stages. The input sequence 0 to 15 can be divided into two sub sequence to perform the computation of division by 2^{K} to take the quotients. In each phase, the same steps can be applied, so the control sequence used for the switches in the first block 801 of the Benes network can be derived according to the CRPT Control algorithm. The control signal used for controlling the second block 802 can be generated by bit control algorithm, and the second block 802 includes log₂ N stages. In the present embodiment, N=16, so the second block 802 includes 4 stages. By using the bit control algorithm, the control signal used to control the switches of the second block 802 in the Benes network can be derived according to bits at the corresponding positions.

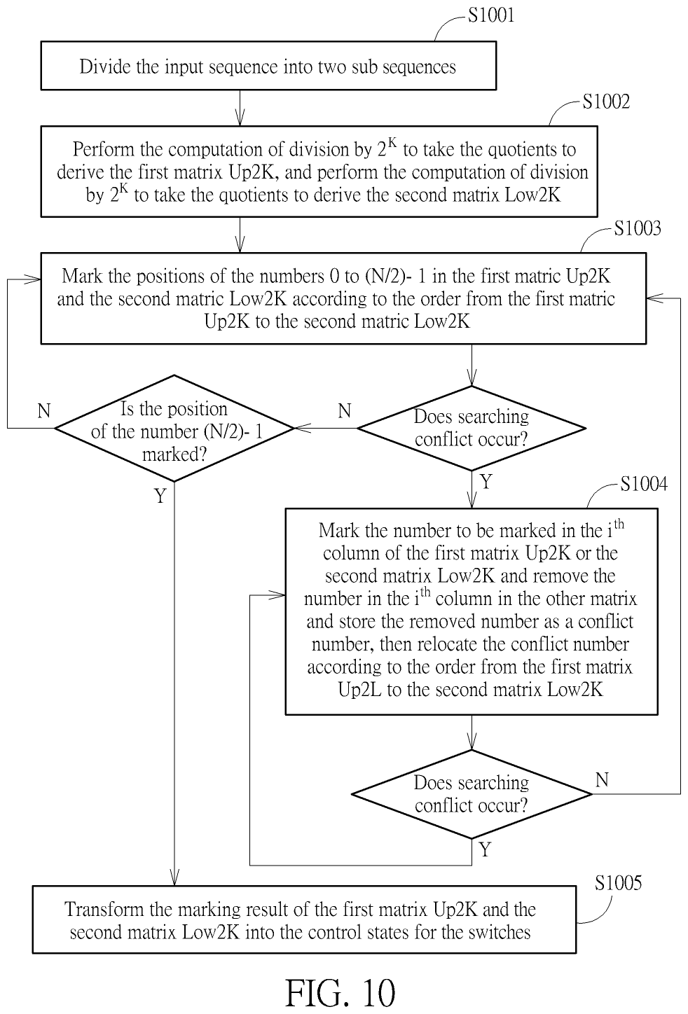

FIG. 10 shows the flowchart of performing the CRPT Control algorithm to the first block 801 in Benes network. In the present embodiment, the first block 801 includes K stages where K=log₂ N−1. For each stage of the first block 801, the following steps are performed.

S1001: divide the input sequence into two sub sequences, numbers at odd positions of the input sequence are selected to form the upper sequence while numbers at even positions of the input sequence are selected to form the lower sequence;

S1002: perform the computation of division by 2^{K} to take the quotients to derive the first matrix Up2K, and perform the computation of division by 2^{K} to take the quotients to derive the second matrix Low2K;

S1003: mark the positions of numbers 0 to (N/2)−1 in the first matric Up2K and the second matric Low2K according to the order from the first matric Up2K to the second matric Low2K; if searching conflict occurs during the marking process, that is, if the number should be marked in the i^{th} column of the first matrix Up2K has been marked in the i^{th} column of the second matrix Low2K, or if the number should be marked in the i^{th} column of the second matrix Low2K has been marked in the i^{th} column of the first matrix Up2K, perform step S1004, otherwise keep performing step S1003 until the position of the number (N/2)−1 is marked;

S1004: mark the number to be marked in the i^{th} column of the first matrix Up2K or the second matrix Low2K and remove the number in the i^{th} column in the other matrix and store the removed number as a conflict number, then relocate the conflict number according to the order from the first matrix Up2L to the second matrix Low2K, if the searching conflict occurs again, perform step S1004 again, otherwise go to step S1003;

S1005: transform the marking result of the first matrix Up2K and the second matrix Low2K into the control states for the switches, if the i^{th} column of the first matrix Up2K is marked, then the i^{th} switch would be controlled to have a state of “0”, if the i^{th} column of the second matrix Low2K is marked, then the i^{th} switch would be controlled to have a state of “1”.

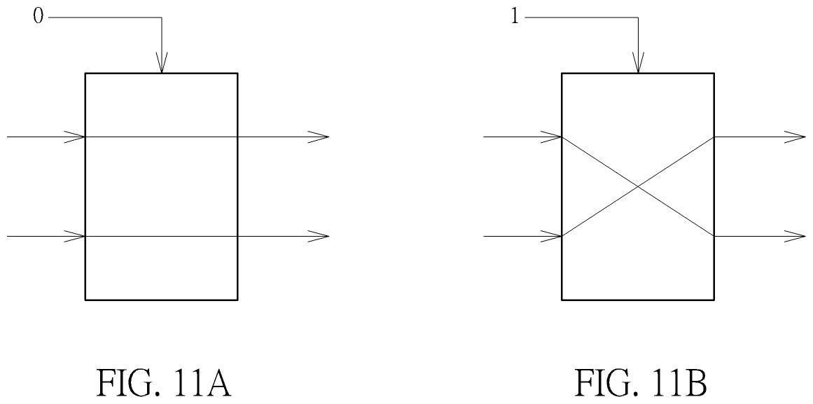

In the first stage when K=1, by performing steps S1001 to S1005, the control states of the switches in the first stage can be derived. In the second stage when K=2, by performing steps S1001 to S1005, the control states of the switches in the second stage can be derived. Similarly, by performing steps S1001 to S1005 for the first stage to the (log₂ N−1)^{th} stage respectively, the control states of all switches in the first block 801 can be derived. FIG. 11A and FIG. 11B show the controlling manner according to one embodiment of the present invention. In FIG. 11A, if the control stage is “0”, the output paths for the input signals would be in parallel. However, in FIG. 11B, if the control stage is “1”, the output paths for the input signals would be crossed.

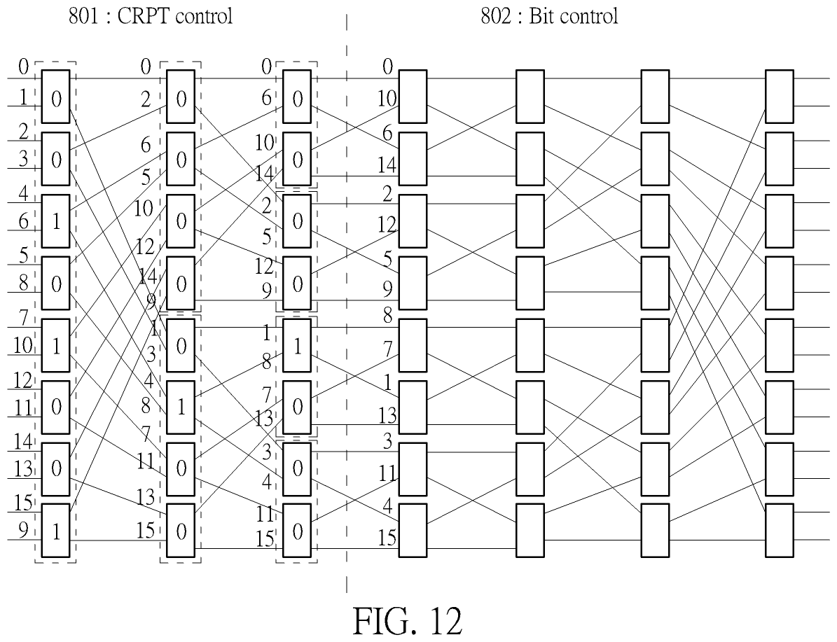

In the embodiment shown in FIG. 12, there are 16 input terminals, that is N=16, and the input sequence of the 16 input terminals is [0,1,2,3,4,6,5,8,7,10,12,11,14,13,15,9], meaning that the peripheral input/output pin 0 is to be coupled to the general-purpose input/output pin 0, the peripheral input/output pin 1 is to be coupled to the general-purpose input/output pin 1, the peripheral input/output pin 2 is to be coupled to the general-purpose input/output pin 2, the peripheral input/output pin 3 is to be coupled to the general-purpose input/output pin 3, the peripheral input/output pin 4 is to be coupled to the general-purpose input/output pin 4, the peripheral input/output pin 5 is to be coupled to the general-purpose input/output pin 6, the peripheral input/output pin 6 is to be coupled to the general-purpose input/output pin 5, the peripheral input/output pin 7 is to be coupled to the general-purpose input/output pin 8, the peripheral input/output pin 8 is to be coupled to the general-purpose input/output pin 7, the peripheral input/output pin 9 is to be coupled to the general-purpose input/output pin 10, the peripheral input/output pin 10 is to be coupled to the general-purpose input/output pin 12, the peripheral input/output pin 11 is to be coupled to the general-purpose input/output pin 11, the peripheral input/output pin 12 is to be coupled to the general-purpose input/output pin 14, the peripheral input/output pin 13 is to be coupled to the general-purpose input/output pin 13, the peripheral input/output pin 14 is to be coupled to the general-purpose input/output pin 15, the peripheral input/output pin 15 is to be coupled to the general-purpose input/output pin 9. In the first stage, when K=1, step S1001 is performed to derive the upper sequence [0,2,4,5,7,12,14,15] by selecting the numbers at the odd positions of the input sequence and the lower sequence [1,3,6,8,10,11,13,9] by selecting the numbers at the even positions of the input sequence. In step S1002, the computation of division by 2¹ to take the quotients is performed, resulting in the first matrix Up2K=[0,1,2,2,3,6,7,7] and the second matrix Low2K=[0,1,3,4,5,5,6,4] as shown in table 1.

TABLE 1

| | | | | | | | | |
|---|---|---|---|---|---|---|---|---|
| Up2K | 0 | 1 | 2 | 2 | 3 | 6 | 7 | 7 |
| Low2K | 0 | 1 | 3 | 4 | 5 | 5 | 6 | 4 |

Afterward, step S1003 would be performed to mark the 0 as shown in table 2. In table 2, the numbers 0 are located at the zeroth positions of the first matrix Up2K and the second matrix Low2K. However, since the first matrix Up2K has a higher priority than the second matrix Low2K, the zeroth position of the first matrix Up2K is marked as “0”.

TABLE 2

| | | | | | | | | |
|---|---|---|---|---|---|---|---|---|
| Up2K | “0” | 1 | 2 | 2 | 3 | 6 | 7 | 7 |
| Low2K | 0 | 1 | 3 | 4 | 5 | 5 | 6 | 4 |

Afterward, “1” is to be marked as shown in table 3. In table 2, the numbers 1 are located at the first positions of the first matrix Up2K and the second matrix Low2K. However, since the first matrix Up2K has a higher priority than the second matrix Low2K, the first position of the first matrix Up2K is marked by “1”.

TABLE 3

| | | | | | | | | |
|---|---|---|---|---|---|---|---|---|
| Up2K | “0” | “1” | 2 | 2 | 3 | 6 | 7 | 7 |
| Low2K | 0 | 1 | 3 | 4 | 5 | 5 | 6 | 4 |

Afterward, “2” is to be marked as shown in table 4. In table 4, the numbers 2 are located at the second position of the first matrix Up2K and the third position of the first matrix Up2K. However, since the second position of the first matrix Up2K is before the third position of the first matrix Up2K, the second position of the first matrix Up2K is marked by “2”.

TABLE 4

| | | | | | | | | |
|---|---|---|---|---|---|---|---|---|
| Up2K | “0” | “1” | “2” | 2 | 3 | 6 | 7 | 7 |
| Low2K | 0 | 1 | 3 | 4 | 5 | 5 | 6 | 4 |

Afterward, “3” is to be marked as shown in table 5. In table 5, the numbers 3 are located at the fourth position of the first matrix Up2K and the second position of the second matrix Low2K. However, since the first matrix Up2K has a higher priority than the second matrix Low2K, the fourth position of the first matrix Up2K is marked by “3”.

TABLE 5

| | | | | | | | | |
|---|---|---|---|---|---|---|---|---|
| Up2K | “0” | “1” | “2” | 2 | “3” | 6 | 7 | 7 |
| Low2K | 0 | 1 | 3 | 4 | 5 | 5 | 6 | 4 |

Afterward, “4” is to be marked as shown in table 6. In table 6, the numbers 4 are located at the third position and the seventh position of the second matrix Low2K. However, since the third position of the second matrix Low2K is before the seventh position of the second matrix Low2K, the third position of the second matrix Low2K is marked by “4”.

TABLE 6

| | | | | | | | | |
|---|---|---|---|---|---|---|---|---|
| Up2K | “0” | “1” | “2” | 2 | “3” | 6 | 7 | 7 |
| Low2K | 0 | 1 | 3 | “4” | 5 | 5 | 6 | 4 |

Afterward, “5” is to be marked as shown in table 7. In table 7, the numbers 5 are located at the fourth position and the fifth position of the second matrix Low2K. Since the fourth position of the second matrix Low2K is before the fifth position of the second matrix Low2K, the fourth position of the second matrix Low2K should be marked by “5”. However, since the fourth position of the first matrix Up2K has been marked, meaning that a searching conflict has occurred, so step S1004 will be performed.

TABLE 7

| | | | | | | | | |
|---|---|---|---|---|---|---|---|---|
| Up2K | “0” | “1” | “2” | 2 | “3” | 6 | 7 | 7 |
| Low2K | 0 | 1 | 3 | “4” | “5” | 5 | 6 | 4 |

To perform step S1004, the mark “5” remains at the fourth position of the second matrix Low2K, and the mark at the fourth position of the first matrix Up2K is replaced by the conflicting number 3. The new marking position of the conflicting number 3 will be found by searching from the first matrix Up2K to the second matrix Low2K sequentially. As shown in table 8, the second position of the second matrix Low2K should be marked by “3”. However, since the second position of the first matrix Up2K has been marked, meaning that another searching conflict has occurred, so step S1004 will be performed again.

TABLE 8

| | | | | | | | | |
|---|---|---|---|---|---|---|---|---|
| Up2K | “0” | “1” | “2” | 2 | 3 | 6 | 7 | 7 |
| Low2K | 0 | 1 | “3” | “4” | “5” | 5 | 6 | 4 |

To perform step S1004, the mark “3” remains at the second position of the second matrix Low2K, and the mark at the second position of the first matrix Up2K is replaced by the conflicting number 2. The new marking position of the conflicting number 2 is found by searching from the first matrix Up2K to the second matrix Low2K sequentially. As shown in table 9, the third position of the first matrix Up2K should be marked by “2”. However, since the third position of the second matrix Up2K has been marked, meaning that another searching conflict has occurred, so step S1004 will be performed again.

TABLE 9

| | | | | | | | | |
|---|---|---|---|---|---|---|---|---|
| Up2K | “0” | “1” | 2 | “2” | 3 | 6 | 7 | 7 |
| Low2K | 0 | 1 | “3” | “4” | “5” | 5 | 6 | 4 |

To perform step S1004, the mark “2” remains at the third position of the first matrix Up2K, and the mark at the third position of the second matrix Low2K is replaced by the conflicting number 4. The new marking position of the conflicting number 4 is found by searching from the first matrix Up2K to the second matrix Low2K sequentially. As shown in table 10, the seventh position of the second matrix Low2K is marked by “4”.

TABLE 10

| | | | | | | | | |
|---|---|---|---|---|---|---|---|---|
| Up2K | “0” | “1” | 2 | “2” | 3 | 6 | 7 | 7 |
| Low2K | 0 | 1 | “3” | 4 | “5” | 5 | 6 | “4” |

Afterward, step S1003 is performed to mark “6” as shown in table 11. In table 11, the numbers 6 are located at the fifth position and the sixth position of the second matrix Low2K. However, since the first matrix Up2K has a higher priority than the second matrix Low2K, the fifth position of the first matrix Up2K is marked by “6”.

TABLE 11

| | | | | | | | | |
|---|---|---|---|---|---|---|---|---|
| Up2K | “0” | “1” | 2 | “2” | 3 | “6” | 7 | 7 |
| Low2K | 0 | 1 | “3” | 4 | “5” | 5 | 6 | “4” |

Afterward, step S1003 is performed to mark “7” as shown in table 12. In table 12, the numbers 7 are located at the sixth position and the seventh position of the first matrix Up2K. Since sixth position of the first matrix Up2K is before the seventh position of the first matrix Up2K, the sixth position of the first matrix Up2K is marked by “7”. At this time, since all (N/2−1) numbers have been marked, step S1005 will be performed.

TABLE 12

| | | | | | | | | |
|---|---|---|---|---|---|---|---|---|
| Up2K | “0” | “1” | 2 | “2” | 3 | “6” | “7” | 7 |
| Low2K | 0 | 1 | “3” | 4 | “5” | 5 | 6 | “4” |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 13, the control states of the switches would be [0,0,1,0,1,0,0,1].

TABLE 13

| | | | | | | | | |
|---|---|---|---|---|---|---|---|---|
| Up2K | “0” | “1” | 2 | “2” | 3 | “6” | “7” | 7 |
| Low2K | 0 | 1 | “3” | 4 | “5” | 5 | 6 | “4” |
| control | 0 | 0 | 1 | 0 | 1 | 0 | 0 | 1 |
| state | | | | | | | | |

As shown in FIG. 12, after performing steps S1001 to S1005, the control states of the switches in the first stage can be derived as [0,0,1,0,1,0,0,1]. Since “0” means parallel output manner while “1” means cross output manner, the original input sequence is divided into two sub sequences [0,2,6,5,10,12,14,9] and [1,3,4,8,7,11,13,15] by the switches in the first stage. In the second stage, the computation of division to take the quotients will be performed. In this case, N=8 and K=2. To calculate the first sequence [0,2,6,5,10,12,14,9], step S1001 is performed by selecting the numbers at the odd positions of the first sequence to derive the upper sequence [0,6,10,14] and selecting the numbers at the even positions of the first sequence to derive the lower sequence [2,5,12,9]. Afterward, the computation of division by 2² is performed in step S1002, and the first matrix Up2K and the second matrix Low2K can be formed by the quotients derived from the division computation as shown in table 14. In table 14, the first matrix Up2K=[0,1,2,3] and the second matrix Low2K=[0,1,3,2].

TABLE 14

| | | | | |
|---|---|---|---|---|
| Up2K | 0 | 1 | 2 | 3 |
| Low2K | 0 | 1 | 3 | 2 |

Later, step S1003 is performed to mark “0” as shown in table 15. In table 15, the numbers 0 are located at the zeroth position of the first matrix Up2K and the zeroth position of the second matrix Low2K. Since the first matrix Up2K has a higher priority than the second matrix Low2K, the zeroth position of the first matrix Up2K is marked by “0”.

TABLE 15

| | | | | |
|---|---|---|---|---|
| Up2K | “0” | 1 | 2 | 3 |
| Low2K | 0 | 1 | 3 | 2 |

Next, as shown in table 16, the numbers 1 are located at the first position of the first matrix Up2K and the first position of the second matrix Low2K. Since the first matrix Up2K has a higher priority than the second matrix Low2K, the first position of the first matrix Up2K is marked by “1”.

TABLE 16

| | | | | |
|---|---|---|---|---|
| Up2K | “0” | “1” | 2 | 3 |
| Low2K | 0 | 1 | 3 | 2 |

Next, as shown in table 17, the numbers 2 are located at the second position of the first matrix Up2K and the third position of the second matrix Low2K. Since the first matrix Up2K has a higher priority than the second matrix Low2K, the second position of the first matrix Up2K is marked by “2”.

TABLE 17

| | | | | |
|---|---|---|---|---|
| Up2K | “0” | “1” | “2” | 3 |
| Low2K | 0 | 1 | 3 | 2 |

Next, as shown in table 18, the numbers 3 are located at the third position of the first matrix Up2K and the second position of the second matrix Low2K. Since the first matrix Up2K has a higher priority than the second matrix Low2K, the third position of the first matrix Up2K is marked by “3”. At this time, since all (N/2−1) numbers have been marked, step S1005 will be performed.

TABLE 18

| | | | | |
|---|---|---|---|---|
| Up2K | “0” | “1” | “2” | “3” |
| Low2K | 0 | 1 | 3 | 2 |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 19, the control states of the switches would be [0,0,0,0].

TABLE 19

| | | | | |
|---|---|---|---|---|
| Up2K | “0” | “1” | “2” | “3” |
| Low2K | 0 | 1 | 3 | 2 |
| Control | 0 | 0 | 0 | 0 |
| state | | | | |

Next, the second sequence [1,3,4,8,7,11,13,15] in the second stage will be addressed. The step S1001 is performed by selecting the numbers at odd positions of the second sequence to derive the upper sequence [1,4,7,13] and selecting the numbers at even positions of the second sequence to derive the lower sequence [3,8,11,15]. Afterward, the computation of division by 2² is performed in step S1002, and the first matrix Up2K and the second matrix Low2K can be formed by the taking the quotients from the division computation as shown in table 20. In table 20, the first matrix Up2K=[0,1,1,3] and the second matrix Low2K=[0,2,2,3].

TABLE 20

| | | | | |
|---|---|---|---|---|
| Up2K | 0 | 1 | 1 | 3 |
| Low2K | 0 | 2 | 2 | 3 |

Next, as shown in table 21, the numbers 0 are located at the zeroth position of the first matrix Up2K and the zeroth position of the second matrix Low2K. Since the first matrix Up2K has a higher priority than the second matrix Low2K, the zero position of the first matrix Up2K will be marked by “0”.

TABLE 21

| | | | | |
|---|---|---|---|---|
| Up2K | “0” | 1 | 1 | 3 |
| Low2K | 0 | 2 | 2 | 3 |

Next, as shown in table 22, the numbers 1 are located at the first position of the first matrix Up2K and the second position of the first matrix Up2K. Since the first position of the first matrix Up2K is before the second position of the first matrix Up2K, the first position of the first matrix Up2K is marked by “1”.

TABLE 22

| | | | | |
|---|---|---|---|---|
| Up2K | “0” | “1” | 1 | 3 |
| Low2K | 0 | 2 | 2 | 3 |

Next, as shown in table 23, the numbers 2 are located at the first position and the second position of the second matrix Low2K. Since the first position of the second matrix Low2K is before the second position of the second matrix Low2K, the first position of the second matrix Low2K is marked by “2”. However, the first position of the first matrix Up2K has been marked, which means that a searching conflict has occurred, and step S1004 will be performed.

TABLE 23

| | | | | |
|---|---|---|---|---|
| Up2K | “0” | “1” | 1 | 3 |
| Low2K | 0 | “2” | 2 | 3 |

To perform step S1004, the mark “2” remains at the first position of the second matrix Low2K, and the mark “1” at the first position of the first matrix Up2K is replaced by the conflicting number 1. The new marking position of the conflicting number 1 is found by searching from the first matrix Up2K to the second matrix Low2K sequentially. As shown in table 24, the second position of the first matrix Up2K is marked by “1”.

TABLE 24

| | | | | |
|---|---|---|---|---|
| Up2K | “0” | 1 | “1” | 3 |
| Low2K | 0 | “2” | 2 | 3 |

Next, step S1003 is performed to mark “3”. As shown in table 25, the numbers 3 are located at the third position of the first matrix Up2K and the third position of the second matrix Low2K. Since the first matrix Up2K has a higher priority than the second matrix Low2K, the third position of the first matrix Up2K is marked by “3”. At this time, since all (N/2−1) numbers have been marked, step S1005 will be performed.

TABLE 25

| | | | | |
|---|---|---|---|---|
| Up2K | “0” | 1 | “1” | “3” |
| Low2K | 0 | “2” | 2 | 3 |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 26, the control states of the switches would be [0,1,0,0].

TABLE 26

| | | | | |
|---|---|---|---|---|
| Up2K | “0” | 1 | “1” | “3” |
| Low2K | 0 | “2” | 2 | 3 |
| Control | 0 | 1 | 0 | 0 |
| state | | | | |

In the second stage, after the calculation for the first sequence [0,2,6,5,10,12,14,9], the control states for the switches can be derived as shown in table 19. Also, after the calculation for the second sequence [1,3,4,8,7,11,13,15], the control states for the switches can be derived as shown in table 26. Consequently, the control states for all the switches in the second stage can be derived as shown in FIG. 12.

As shown in FIG. 12, after the second stage, the original input sequence will be divided into four sub sequence [0,6,10,14], [2,5,12,9], [1,8,7,13], and [3,4,11,15] by the switches in the first stage and the second stage. In the third stage, the computation of division to take the quotients will be performed to the four sub sequences. In this case, N=4 and K=3. To calculate the first sequence [0,6,10,14], step S1001 is performed by selecting the numbers at odd positions of the first sequence to derive the upper sequence [0,10] and selecting the numbers at even positions of the first sequence to derive the lower sequence [6,14]. Afterward, the computation of division by 2³ is performed in step S1002, and the first matrix Up2K and the second matrix Low2K can be formed by the quotients derived from the division computation as shown in table 27. In table 27, the first matrix Up2K=[0,1] and the second matrix Low2K=[0,1].

TABLE 27

| | | |
|---|---|---|
| Up2K | 0 | 1 |
| Low2K | 0 | 1 |

Later, step S1003 is performed to mark “0” as shown in table 28. In table 28, the numbers 0 are located at the zeroth position of the first matrix Up2K and the zeroth position of the second matrix Low2K. Since the first matrix Up2K has a higher priority than the second matrix Low2K, the zeroth position of the first matrix Up2K is marked by “0”.

TABLE 28

| | | |
|---|---|---|
| Up2K | “0” | 1 |
| Low2K | 0 | 1 |

Next, as shown in table 29, the numbers 1 are located at the first position of the first matrix Up2K and the first position of the second matrix Low2K. Since the first matrix Up2K has a higher priority than the second matrix Low2K, the first position of the first matrix Up2K is marked by “1”. At this time, since all (N/2−1) numbers have been marked, step S1005 will be performed.

TABLE 29

| | Up2K | |
|---|---|---|
| | “0” | “1” |
| Low2K | 0 | 1 |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 30, the control states of the switches would be [0,0].

TABLE 30

| | Up2K | |
|---|---|---|
| | “0” | “1” |
| Low2K | 0 | 1 |
| Control | 0 | 0 |
| state | | |

Next, the second sequence [2,5,12,9] in the third stage will be addressed. The step S1001 is performed by selecting the numbers at odd positions of the second sequence to derive the upper sequence [2,12] and selecting the numbers at even positions of the second sequence to derive the lower sequence [5,9]. Afterward, the computation of division by 2³ is performed in step S1002, and the first matrix Up2K and the second matrix Low2K can be formed by the taking the quotients from the division computation as shown in table 30. In table 30, the first matrix Up2K=[0,1] and the second matrix Low2K=[0,1].

TABLE 31

| | Up2K | |
|---|---|---|
| | 0 | 1 |
| Low2K | 0 | 1 |

Later, step S1003 is performed to mark “0” as shown in table 32. In table 32, the numbers 0 are located at the zeroth position of the first matrix Up2K and the zeroth position of the second matrix Low2K. Since the first matrix Up2K has a higher priority than the second matrix Low2K, the zeroth position of the first matrix Up2K is marked by “0”.

TABLE 32

| | Up2K | |
|---|---|---|
| | 0 | 1 |
| Low2K | 0 | 1 |

Next, as shown in table 33, the numbers 1 are located at the first position of the first matrix Up2K and the first position of the second matrix Low2K. Since the first matrix Up2K has a higher priority than the second matrix Low2K, the first position of the first matrix Up2K is marked by “1”. At this time, since all (N/2−1) numbers have been marked, step S1005 will be performed.

TABLE 33

| | Up2K | |
|---|---|---|
| | “0” | “1” |
| Low2K | 0 | 1 |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 34, the control states of the switches would be [0,0].

TABLE 34

| | Up2K | |
|---|---|---|
| | “0” | “1” |
| Low2K | 0 | 1 |
| Control | 0 | 0 |
| state | | |

Next, the third sequence [1,8,7,13] in the third stage will be addressed. The step S1001 is performed by selecting the numbers at odd positions of the third sequence to derive the upper sequence [1,7] and selecting the numbers at even positions of the third sequence to derive the lower sequence [8,13]. Afterward, the computation of division by 2³ is performed in step S1002, and the first matrix Up2K and the second matrix Low2K can be formed as shown in table 35. In table 35, the first matrix Up2K=[0,0] and the second matrix Low2K=[1,1].

TABLE 35

| | Up2K | |
|---|---|---|
| | 0 | 0 |
| Low2K | 1 | 1 |

Later, step S1003 is performed to mark “0” as shown in table 36. In table 36, the numbers 0 are located at the zeroth position of the first matrix Up2K and the first position of the first matrix Up2K. Since the zero position of the first matrix Up2K is before the first position of the first matrix Up2K, the zeroth position of the first matrix Up2K is marked by “0”.

TABLE 36

| | Up2K | |
|---|---|---|
| | “0” | 0 |
| Low2K | 1 | 1 |

Next, as shown in table 37, the numbers 1 are located at the zeroth position and the first position of the second matrix Low2K. Since the zeroth position of the second matrix Low2K is before the first position of the second matrix Low2K, the zeroth position of the second matrix Low2K will be marked by “1”. However, since the zeroth position of the first matrix Up2K has been marked, step S1004 will be performed to address the searching conflict.

TABLE 37

| | Up2K | |
|---|---|---|
| | “0” | 0 |
| Low2K | “1” | 1 |

To perform step S1004, the mark “1” remains at the zeroth position of the second matrix Low2K, and the mark “0” at the zeroth position of the first matrix Up2K is replaced by the conflicting number 0. The new marking position of the conflicting number 0 is found by searching from the first matrix Up2K to the second matrix Low2K sequentially. As shown in table 38, the first position of the first matrix Up2K is marked by “0”. At this time, since all (N/2−1) numbers have been marked, step S1005 will be performed.

TABLE 38

| | Up2K | |
|---|---|---|
| | 0 | “0” |
| Low2K | “1” | 1 |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 39, the control states of the switches would be [1,0].

TABLE 39

| | Up2K | |
|---|---|---|
| | 0 | “0” |
| Low2K | “1” | 1 |
| Control | 1 | 0 |
| state | | |

Next, the fourth sequence [3,4,11,15] in the third stage will be addressed. The step S1001 is performed by selecting the numbers at odd positions of the fourth sequence to derive the upper sequence [3,11] and selecting the numbers at even positions of the fourth sequence to derive the lower sequence [4,15]. Afterward, the computation of division by 2³ is performed in step S1002, and the first matrix Up2K and the second matrix Low2K can be formed as shown in table 40. In table 40, the first matrix Up2K=[0,1] and the second matrix Low2K=[0,1].

TABLE 40

| | Up2K | |
|---|---|---|
| | 0 | 1 |
| Low2K | 0 | 1 |

Later, step S1003 is performed to mark “0” as shown in table 41. In table 36, the numbers 0 are located at the zeroth position of the first matrix Up2K and the zeroth position of the second matrix Low2K. Since the first matrix Up2K has a higher priority than the second matrix Low2K, the zeroth position of the first matrix Up2K is marked by “0”.

TABLE 41

| | Up2K | |
|---|---|---|
| | “0” | 1 |
| Low2K | 0 | 1 |

Next, step S1003 is performed to mark “1” as shown in table 42. In table 42, the numbers 1 are located at the first position of the first matrix Up2K and the first position of the second matrix Low2K. Since the first matrix Up2K has a higher priority than the second matrix Low2K, the first position of the first matrix Up2K is marked by “1”. At this time, since all (N/2−1) numbers have been marked, step S1005 will be performed.

TABLE 42

| | Up2K | |
|---|---|---|
| | “0” | “1” |
| Low2K | 0 | 1 |

To perform step S1005, if the number is marked at the i^{th} column of the first matrix Up2K, the control state of the i^{th} switch would be 0. However, if the number is marked at the i^{th} column of the second matrix Low2K, the control state of the i^{th} switch would be 1. As shown in Table 43, the control states of the switches would be [0,0].

TABLE 43

| | Up2K | |
|---|---|---|
| | “0” | “1” |
| Low2K | 0 | 1 |
| Control | 0 | 0 |
| state | | |

In the third stage, after the calculation for the four sequences [0,6,10,14], [2,5,12,9], [1,8,7,13], and [3,4,11,15], the control states for the switches can be derived as shown in table 30, 34, 39, and 43. Also, to combine the control states derived from the four sequences, the control states for the switches in the third stage can be derived as [0,0,0,0,1,0,0,0] as shown in FIG. 12. Consequently, the control states for all the switches in the first block 801 can be derived with the CRPT Control algorithm.

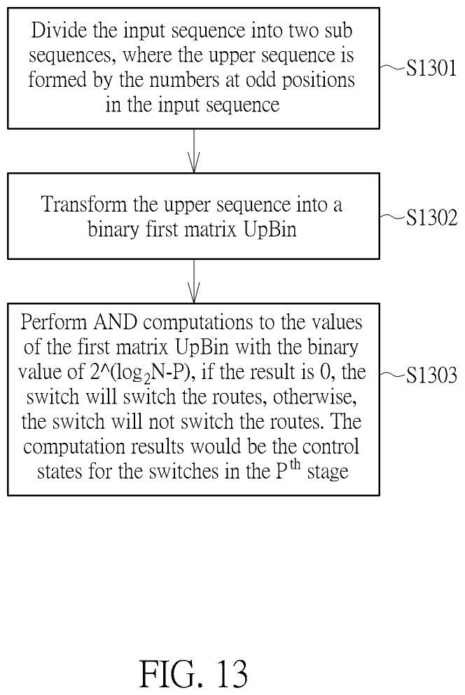

FIG. 13 shows the flowchart of performing the bit control algorithm to the second block 802 in Benes network. In the present embodiment, the second block 802 includes P stages where P=log₂ N. For each stage of the second block 802, the following steps are performed.

S1301: divide the input sequence into two sub sequences, where the upper sequence is formed by the numbers at odd positions in the input sequence;

S1302: transform the upper sequence into a binary first matrix UpBin;

S1303: perform AND computations to the values of the first matrix UpBin with the binary value of 2\hat{ }(log₂N−P), if the result is 0, the switch will switch the routes, otherwise, the switch will not switch the routes. The computation results would be the control states for the switches in the P^{th} stage.

In the first stage (P=1) of the second block 802, by performing steps S1301 to S1303, the control states of the switches in the first stage can be derived. Similarly, the control states of other stages can be derived by performing steps S1301 to S1303. Consequently, the control states of all the switches in the second block 802 can be derived.

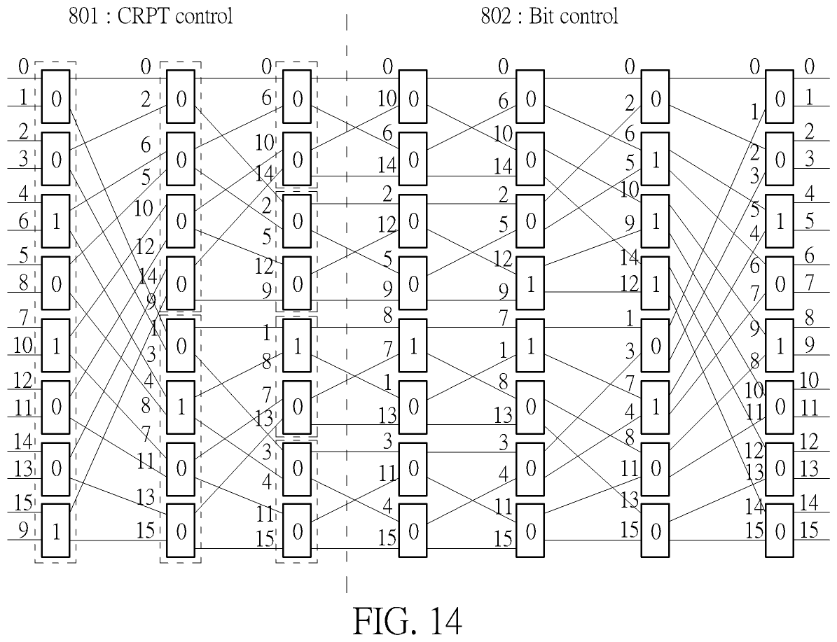

Continue with the sequence shown in FIG. 12, each stage of the second block 802 can be addressed with the bit control algorithm as shown in FIG. 14. In the present embodiment, the input sequence for the second block 802 of the Benes network is [0,10,6,14,2,12,5,9,8,7,1,13,3,11,4,15]. In the first stage, P=1 and N=16. According to step S1301, the input sequence can be divided into two sub sequences. The upper sequence can be formed by selecting numbers at the odd positions of the input sequence and would be [0,6,2,5,8,1,3,4] in this case. Next, step S1302 is performed to transform the upper sequence into the first matrix UpBin in the binary form as shown in the second row of the table 44. Next, step S1303 is performed. That is, the AND computations will be performed to the values in the first matrix UpBin with 2\hat{ }(log₂ N−P) in the binary form. In this case, since N=16 and P=1, the 2\hat{ }(log₂ N−P) would be 2³, or 1000 when represented in binary form. The computation result is shown in the third row of the table 44. If the result is 0000, it means that the switch will not switch the routes, that is, the control state would be 0. Otherwise, if the switch needs to switch the routes, then the control state would be 1. The control states are shown in the fourth row of the table 44.

TABLE 44

| | | | | | | | | |
|---|---|---|---|---|---|---|---|---|
| Up2K | 0 | 6 | 2 | 5 | 8 | 1 | 3 | 4 |
| UpBin | 0000 | 0110 | 0010 | 0101 | 1000 | 0001 | 0011 | 0100 |
| Computation | 0000 | 0000 | 0000 | 0000 | 1000 | 0000 | 0000 | 0000 |
| result | | | | | | | | |
| Control state | 0 | 0 | 0 | 0 | 1 | 0 | 0 | 0 |

The input sequence for the second stage of the second block 802 after rearranged by the switches in the first stage of the second block 802 is [0,6,10,14,2,5,12,9,7,1,8,13,3,4,11,15]. In the second stage, P=2 and N=16. According to step S1301, the input sequence can be divided into two sub sequences. The upper sequence can be formed by selecting numbers at odd positions of the input sequence and would be [0,10,2,12,7,8,3,11] in this case. Next, step S1302 is performed to transform the upper sequence into the first matrix UpBin in the binary form as shown in the second row of the table 45. Next, step S1303 is performed. That is, the AND computations will be performed to the values in the first matrix UpBin with 2\hat{ }(log₂ N−P) in the binary form. In this case, since N=16 and P=2 so 2\hat{ }(log₂ N−P)=2². The computation result is shown in the third row of the table 45. If the result is 0000, it means that the switch will not switch the routes, that is, the control state would be 0. Otherwise, if the switch needs to switch the routes, then the control state would be 1. The control states are shown in the fourth row of the table 45.

TABLE 45

| | | | | | | | | |
|---|---|---|---|---|---|---|---|---|
| Up2K | 0 | 10 | 2 | 12 | 7 | 8 | 3 | 11 |
| UpBin | 0000 | 1010 | 0010 | 1100 | 0111 | 10 00 | 0011 | 1011 |
| Computation | 0000 | 0000 | 0000 | 0100 | 0100 | 0000 | 0000 | 0000 |
| result | | | | | | | | |
| Control state | 0 | 0 | 0 | 1 | 1 | 0 | 0 | 0 |

The input sequence for the third stage of the second block 802 after rearranged by the switches in the first stage and the second stage of the second block 802 is [0,2,6,5,10,9,14,12,1,3,7,4,8,11,13,15]. In the second stage, P=3 and N=16. According to step S1301, the input sequence can be divided into two sub sequences. The upper sequence can be formed by selecting numbers at odd positions of the input sequence and would be [0,6,10,14,1,7,8,13] in this case. Next, step S1302 is performed to transform the upper sequence into the first matrix UpBin in the binary form as shown in the second row of the table 46. Next, step S1303 is performed. That is, the AND computations will be performed to the values in the first matrix UpBin with 2\hat{ }(log₂ N−P) in the binary form. In this case, since N=16 and P=3 so 2\hat{ }(log₂ N−P)=2¹. The computation result is shown in the third row of the table 46. If the result is 0000, it means that the switch will not switch the routes, that is, the control state would be 0. Otherwise, if the switch needs to switch the routes, then the control state would be 1. The control states are shown in the fourth row of the table 46.

TABLE 46

| | | | | | | | | |
|---|---|---|---|---|---|---|---|---|
| Up2K | 0 | 6 | 10 | 14 | 1 | 7 | 8 | 13 |
| UpBin | 0000 | 0110 | 1010 | 1110 | 0001 | 0111 | 1000 | 1101 |
| Computation | 0000 | 0010 | 0010 | 0010 | 0000 | 0010 | 0000 | 0000 |
| result | | | | | | | | |
| Control state | 0 | 1 | 1 | 1 | 0 | 1 | 0 | 0 |

The input sequence for the fourth stage of the second block 802 after rearranged by the switches in the first stage, the second stage, and the third stage of the second block 802 is [0,1,2,3,5,4,6,7,9,8,10,11,12,13,14,15]. In the fourth stage, P=4 and N=16. According to step S1301, the input sequence can be divided into two sub sequences. The upper sequence can be formed by selecting numbers at the odd positions of the input sequence and would be [0,2,5,6,9,10,12,14] in this case. Next, step S1302 is performed to transform the upper sequence into the first matrix UpBin in the binary form as shown in the second row of the table 47. Next, step S1303 is performed. That is, the AND computations will be performed to the values in the first matrix UpBin with 2\hat{ }(log₂ N−P) in the binary form. In this case, since N=16 and P=4 so 2\hat{ }(log₂ N−P)=2°. The computation result is shown in the third row of the table 47. If the result is 0000, it means that the switch will not switch the routes, that is, the control state would be 0. Otherwise, if the switch needs to switch the routes, then the control state would be 1. The control states are shown in the fourth row of the table 47.

TABLE 47

| | | | | | | | | |
|---|---|---|---|---|---|---|---|---|
| Up2K | 0 | 2 | 5 | 6 | 9 | 10 | 12 | 14 |
| UpBin | 0000 | 0010 | 0101 | 0110 | 1001 | 1010 | 1100 | 1110 |
| Computation | 0000 | 0000 | 0001 | 0000 | 0001 | 0000 | 0000 | 0000 |
| result | | | | | | | | |
| Control state | 0 | 0 | 1 | 0 | 1 | 0 | 0 | 0 |

The control states for the switches in all the four stages of the second block 802 can be found in tables 44, 45, 46 and 47, and are shown in FIG. 14. Consequently, by adopting the CRTC Control algorithm and the bit control algorithm, the control states for all the switches in the Benes network can be derived.

In the present embodiment, the control states for all the switches in the Benes network can be derived by adopting the CRPT Control algorithm and the bit control algorithm quickly, so the respective connections between the peripheral input/output pins 101 to 10N and the general-purpose input/output pins 111 to 11N can be adjusted dynamically. In some embodiments, the respective connections of the pins can even be changed in different times.

The integrated circuits and the dynamic pin control methods provided by the embodiments of the present invention can control the respective connections between the peripheral input/output pins and the general-purpose input/output pins via the link network with the network control circuit dynamically. The peripheral input/output pins can be the function pins of the integrated circuit. The link network can be the Benes network so the number of gates on each path from the peripheral input/output pins to the general-purpose input/output pins would be the same. Therefore, issue of different gate delays on different paths can be avoided. Furthermore, the correspondence or connection relationship between the pins can be stored in the pin control register so the pin arrangement can be read from the pin control register directly after adjusted when needed. Also, since the pin connections can be assigned and adjusted dynamically, the routing can be more flexible and the current interference caused by routing can be eased. Also, with the integrated circuits and the dynamic pin control methods provided by the embodiments of the present invention, when the number of pins of the package and the number of pins of the IC are different, the peripheral input/output pins can still be used effectively even if the number of peripheral input/output pins is much greater than the number of the general-purpose input/output pins.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated circuit comprising:
a plurality of peripheral input/output pins;
a plurality of general-purpose input/output pins;
a link network coupled to the plurality of peripheral input/output pins and the plurality of general-purpose input/output pins; and
a network control circuit coupled to the link network, and configured to control the respective connections between the plurality of peripheral input/output pins and the plurality of general-purpose input/output pins via the link network according to correspondence between the plurality of peripheral input/output pins and the plurality of general-purpose input/output pins.

2. The integrated circuit of claim 1, wherein the plurality of peripheral input/output pins are function pins of the integrated circuit.

3. The integrated circuit of claim 2 further comprising a pin control register configured to store the correspondence between the plurality of peripheral input/output pins and the plurality of general-purpose input/output pins, wherein the network control circuit comprises a hardware computation unit configured to control the link network.

4. The integrated circuit of claim 2 wherein the network control circuit comprises a software program configured to control the link network.

5. The integrated circuit of claim 1, wherein the link network is Benes network.

6. The integrated circuit of claim 1 further comprising a pin control register configured to store the correspondence between the plurality of peripheral input/output pins and the plurality of general-purpose input/output pins, wherein the network control circuit comprises a hardware computation unit configured to control the link network.

7. The integrated circuit of claim 1 wherein the network control circuit comprises a software program configured to control the link network.

8. A dynamic pin control method for an integrated circuit, the integrated circuit including a plurality of peripheral input/output pins, a plurality of general-purpose input/output pins, a link network coupled to the plurality of peripheral input/output pins and the plurality of general-purpose input/output pins, and a network control circuit coupled to the link network, and the method comprising:
generating by the network control circuit a control signal according to correspondence between the plurality of peripheral input/output pins and the plurality of general-purpose input/output pins; and
controlling respective connections between the plurality of peripheral input/output pins and the plurality of general-purpose input/output pins via the link network according to the control signal.

9. The method of claim 8, wherein the link network is Benes network.

10. The method of claim 9, wherein the network control circuit generating the control signal according to the correspondence between the plurality of peripheral input/output pins and the plurality of general-purpose input/output pins comprises:
generating by the network control circuit the control signal by using complete residue partition tree control and bit control according to the correspondence between the plurality of peripheral input/output pins and the plurality of general-purpose input/output pins.

11. The method of claim 9, wherein the network control circuit generating the control signal according to the correspondence between the plurality of peripheral input/output pins and the plurality of general-purpose input/output pins comprises:
generating by the network control circuit the control signal with a software program according to the correspondence between the plurality of peripheral input/output pins and the plurality of general-purpose input/output pins.

12. The method of claim 9, wherein the network control circuit generating the control signal according to the correspondence between the plurality of peripheral input/output pins and the plurality of general-purpose input/output pins comprises:
generating by the network control circuit the control signal with a hardware computation unit according to the correspondence between the plurality of peripheral input/output pins and the plurality of general-purpose input/output pins.

13. The method of claim 8, wherein the network control circuit generating the control signal according to the correspondence between the plurality of peripheral input/output pins and the plurality of general-purpose input/output pins comprises:
generating by the network control circuit the control signal by using complete residue partition tree control and bit control according to the correspondence between the plurality of peripheral input/output pins and the plurality of general-purpose input/output pins.

14. The method of claim 8, wherein the network control circuit generating the control signal according to the correspondence between the plurality of peripheral input/output pins and the plurality of general-purpose input/output pins comprises:
generating by the network control circuit the control signal with a software program according to the correspondence between the plurality of peripheral input/output pins and the plurality of general-purpose input/output pins.

15. The method of claim 8, wherein the network control circuit generating the control signal according to the correspondence between the plurality of peripheral input/output pins and the plurality of general-purpose input/output pins comprises:
generating by the network control circuit the control signal with a hardware computation unit according to the correspondence between the plurality of peripheral input/output pins and the plurality of general-purpose input/output pins.
